(19) United States
(12) Patent Application Publication
(10) Pub. No.: US 2023/0352790 A1
(43) Pub. Date: Nov. 2, 2023

(54) BATTERY AND BATTERY HOLDER ARRANGEMENT FOR A LIGHT ELECTRIC VEHICLE

(71) Applicant: REVONTE OY, Tampere (FI)

(72) Inventors: Jere KOSKINEN, Tampere (FI); Jan KLEIN, Tampere (FI)

(21) Appl. No.: 18/013,690

(22) PCT Filed: Jul. 2, 2021
(86) PCT No.: PCT/FI2021/050512

§ 371 Date: Dec. 29, 2022

(30) Foreign Application Priority Data
Jul. 3, 2020 (FI) 20205716

(51) Int. Cl. H01M 50/249; H01M 50/204; H01M 50/262

(52) U.S. Cl. CPC H01M 50/249; H01M 50/204; H01M 50/262; H01M 2220/20

(57) ABSTRACT

A battery for light electric vehicles, and a related battery holder arrangement is disclosed. The battery includes a mortise end cap at the first end of the battery. The end cap has a first direction mortise end cap base surface and a second direction mortise end cap base surface, and one or more first direction notches each having a distal end aligned in the first direction, and one or more second direction notches each having a distal end aligned in the second direction. The distal end of each of the one or more first direction notches and the distal end of each of the one or more second direction notches are at a first and at a second support distance from the base surfaces they are opposite to, respectively.

### FIELD OF THE INVENTION

The present invention relates to a battery for a light electric vehicle, and more particularly to a battery according to preamble of claim 1. The present invention also relates to a battery holder arrangement, and more particularly to a battery holder arrangement according to preamble of claim 14.

### BACKGROUND OF THE INVENTION

Electric vehicles, in particular light electric vehicles like electric bicycles, e-bikes or electric motorcycles are getting more and more popular among consumers and vehicle sharing systems. All light electric vehicles share many preferable qualities. They are light weight, have virtually no exhausts and very low noise emissions and are yet able to move persons at feasible speeds and distances. Light electric vehicles come in various forms, some having only a small electric motor to assist the rider's pedaling (e.g. a pedelec), some having three or four wheels and having just an electric motor for propulsion.

Common features to all light electric vehicle are as follows: they all have either an assisting or a main electric motor to move the vehicle, and to energize the motor, they all must have access to a portable form of energy usable in an electric motor. This practically means that the vehicles must carry a battery that stores electric energy in form of electric charge at a certain voltage level. Also fuel cell technologies are emerging for this purpose, but their widespread adoption in the industry is still mostly in the future.

Batteries for light electric vehicles must meet various requirements. To facilitate charging, they are preferably detachable from the vehicle as vehicles are often stored in places with no electric outlets. Instead, it is often easier to take just the battery inside and charge it with a charger and leave the vehicle outside. This imposes various needs for the weight, size and shape of the battery, and also to the ways the battery is inserted to, held in and detached from the vehicle. If it is difficult or cumbersome to operate the battery in and out of the vehicle or the battery is not held firmly enough, user experience suffers and in the worst case the vehicle is rendered unusable.

For the light electric vehicle industry, shape, size and form of the battery are important factors as also the vehicles come in different shapes, forms and sizes. Often it is advantageous to place the battery inside the frame of the vehicle to safeguard it from environmental effects like water, dirt, wear and impacts. Space available for the battery inside the frame is naturally determined mostly by the outer design of the frame. This, in turn, is mostly determined by aesthetic, mechanical and aerodynamic considerations. To be widely usable, a battery is preferably a longitudinal volume and having a longitudinal cross section e.g. of a rounded rectangle with different height and width dimensions to suit vehicle frames having a “thick and short” or a “thin and tall” cross section. Ideally, a same battery would fit in as many in-frame installations as possible with only minimal modifications. The same is true also for battery attachments outside the frame where space is also limited to maintain a streamlined and aerodynamic shape for the vehicle's configuration.

Primary challenge in using batteries of different cross sectional shapes is the following: How to insert and detach the battery both mechanically and electrically in a robust way into the frame of the bike and couple it with energy consuming components like the electric motor firmly. Advantageously, the mechanical and electric elements of the coupling are changed as little as possible from one orientation of the battery to another to enable mass production of as few battery types as possible.

In the prior art, this has been challenging. Changing the orientation of the battery has necessitated a broad range of modifications to the mechanical and electric connection units of the battery and frame of the vehicle. Usually, two completely different battery units are needed for two different orientations, making production, interoperability, value chain and logistics more difficult. Different battery units usually also require a separate certification process, which is time consuming and expensive.

Thus, there is a need to improve to possibility to attach and detach a battery into a light electric vehicle in different orientations with minimal or no changes to the electric and mechanical attachment related units of the battery and of the battery holder.

### BRIEF DESCRIPTION OF THE INVENTION

An object of the present invention is to provide a battery for light electric vehicles so that the prior art disadvantages are solved or at least alleviated. The objects of the invention are achieved by a battery according to the independent claim 1. The objects of the invention are further achieved by a battery holder arrangement according to the independent claim 14.

The preferred embodiments of the invention are disclosed in the dependent claims.

The invention is based on the idea of providing the battery with an end cap with attachment related notches in two different directions and arranging the notches so that they may support the battery during holding of the battery in the battery holder in all (that is, two different) attachment orientations. Support means holding the battery in a robust way and carrying at least part of its weight.

Advantage of the invention is that the battery can be rigidly attached in two different orientations with no change to the mechanical attachment of the battery, and potentially only a small adjustment to the electric connection. By separating electric and mechanical connection points to the end cap from the battery frame also increases the modularity and interchangeability of the parts of the battery.

According to the present invention, a battery for a light electric vehicle comprises a first end, a second end, at least one electric connector and at least one battery cell connected to the at least one electric connector. The battery comprises a mortise end cap at the first end of the battery. The mortise end cap comprises a first end face, a first direction mortise end cap base surface and a second direction mortise end cap base surface. The first direction mortise end cap base surface is arranged in a first direction and the second direction mortise end cap base surface is arranged perpendicularly relative to the first direction in a second direction. The mortise end cap comprises one or more first direction notches each having a distal end aligned in the first direction and a proximal end relative to the first direction mortise end cap base surface. The mortise end cap comprises one or more second direction notches each having a distal end aligned in the second direction and a proximal end relative to the second direction mortise end cap base surface. Moreover, the distal end of each of the one or more first direction notches and the first direction mortise end cap base surface are at a first support distance from each other. The distal end of each of the one or more second direction notches and the second direction mortise end cap base surface are at a second support distance from each other. With this arrangement, a battery with a different size in first and second dimensions of the cross section (e.g. a non-square cross section) can be held in two different orientations in the battery holder with minimal or no changes to the battery holder.

According to an embodiment, the first support distance and the second support distance are equal. This embodiment allows that the base surfaces of the mortise end cap also aid in supporting the battery as they will be placed on equal distances from the distal ends of the notches that mainly support the first end of the battery.

According to an embodiment, the one or more first direction notches have a substantially concave shape in the second direction. By the same token, the one or more second direction notches have a substantially concave shape in the first direction. Concave shape is advantageous as it enables smooth rotation and pivoting of the battery during insertion and detachment.

According to another embodiment, the one or more first direction notches and the one or more second direction notches at the mortise end cap all have an equal size. Equal sizes for the first direction notches and second direction notches at the mortise end cap simplify the design of the battery holder and the end cap.

According to still another embodiment, the one or more first direction notches and the one or more second direction notches at the mortise end cap have at least two different sizes. Different sizes for the notches help in mistake-proofing (so-called poka-yoke) the insertion as a small notch will not fit into a large wing or protrusion of the battery holder.

According to an embodiment, the mortise end cap comprises a first direction mortise end cap free surface and a second direction mortise end cap free surface. The mortise end cap comprises one or more first direction notches between the center of the first end face and the second direction mortise end cap base surface, one or more first direction notches between the center of the first end face and the second direction mortise end cap free surface, one or more second direction notches between the center of the first end face and the first direction mortise end cap base surface, and one or more second direction notches between the center of the first end face and the first direction mortise end cap free surface. It is advantageous to place the notches around the center point of the first end face for a good holding in a battery holder.

According to an embodiment, the battery further comprises a threadhole end cap at the second end of the battery, the threadhole end cap comprising one or more first direction threaded holes and one or more second direction threaded holes. One or more first direction threaded holes and one or more second direction threaded holes are arranged perpendicularly relative to each other. Threaded holes (when coupled with a bolt) are a way of affixing the battery to the battery holder.

According to yet another embodiment, the battery further comprises a grooved end cap at the second end of the battery. The grooved end cap comprises two grooved end cap base surfaces arranged perpendicularly in the first direction and the second direction, respectively. The grooved end cap comprises one or more first direction notched grooves, each having a distal end aligned in the first direction and a proximal end relative to the first direction grooved end cap base surface. The grooved end cap comprises still one or more second direction notched grooves, each a having distal end aligned in the second direction and a proximal end relative to the second direction grooved end cap base surface. The distal end of each of the one or more first direction notched grooves is at a first latch distance from the first direction grooved end cap base surface, and the distal end of each of the one or more second direction notched grooves is at a second latch distance from the second direction grooved end cap base surface. The first latch distance and the second latch distance are equal. In other words, grooved end cap is arranged to lock the battery in position with one or more latches that, just as in the mortise end cap, operates in different orientations of the battery with no modifications needed for the battery or its holder at the second end.

Still according to an embodiment, each of the first direction notched grooves and each of the second direction notched grooves are symmetric along their respective center lines. Symmetric shape of the notched grooves is advantageous to facilitate a smooth insertion and firm holding of the battery.

According to another embodiment, the center lines of each of the first direction notched grooves and the center lines of each of the second direction notched grooves intersect perpendicularly. Perpendicular relative orientation of the notched grooves allows for two different perpendicular holding orientations of the battery.

According to yet another embodiment, the electric connector is arranged at the center of the first end face. This location for the electric connector makes it simple to allow for two different orientations of the battery as the only modification maybe needed when changing from orientation to another is to alter the position of the electric socket of the battery holder slightly, and rotate it according to the rotation of the orientation of the battery, usually 90 degrees. According to still another embodiment the electric connector is arranged on the first direction mortise end cap base surface, or on the second direction mortise end cap base surface. The base surfaces of the mortise end cap are also locations where an electric self-mating connection can be easily provided.

According to an embodiment, the electric connector is arranged on the first direction grooved end cap base surface, or on the second direction grooved end cap base surface. As with mortise end cap base surfaces, the base surfaces of the grooved end cap are also locations where an electric self-mating connection can easily be provided.

As an aspect of the present invention, the present invention relates also to a battery holder arrangement. The battery of the battery holder arrangement is a battery as defined in the present application. The battery holder arrangement comprises a battery holder. Each of the one or more protrusions comprises a support surface. The battery holder comprises a fixed end, and the fixed end comprises one or more one protrusions. At least one first direction notch is arranged to mate with at least one protrusion when the battery is held and operated in the first direction, and at least one second direction notch is arranged to mate with at least one same protrusion when the battery is held and operated in the second direction. The at least one protrusion is arranged to support the battery during holding of the battery in the battery holder.

As an embodiment, the battery rotates around the support surface of the at least one protrusion of the battery holder during insertion of the battery to the battery holder, and during detachment of the battery from the battery holder.

### BRIEF DESCRIPTION OF THE DRAWINGS

The invention is described in detail by means of specific embodiments with reference to the enclosed drawings, in which

FIG. 1a shows an example of a prior art light electric vehicle,

FIG. 1b shows two examples of positioning and of the orientations of the battery inside of a frame of a light electric vehicle, as a cross section when looking in the direction of the longest dimension of the battery,

FIG. 2 shows the concept of directions and dimensions of the cross section used in the present application,

FIGS. 3a and 3b show a prior art battery connection arrangement,

FIG. 4 shows the first end and the end cap of an embodiment of a battery according to the present invention,

FIG. 5a shows another end cap of a battery according to another embodiment of the present invention,

FIG. 5b shows yet another end cap of a battery according to another embodiment of the present invention,

FIG. 6 shows yet another end cap of a battery according to another embodiment of the present invention,

FIG. 7 shows an end cap at the second end of the battery according to another embodiment of the present invention,

FIG. 8 shows an example of a battery holder suitable for holding a battery according to an embodiment of the present invention in different projections,

FIG. 9 shows an insertion of a battery in an orientation according to an embodiment of the present invention,

FIG. 10 shows an insertion of a battery in another orientation according to an embodiment of the present invention, and

FIG. 11 shows an example of a battery holder suitable for holding a battery according to an embodiment of the present invention.

### DETAILED DESCRIPTION OF THE INVENTION

In the following description, like numbers (e.g. 20) or labels (e.g. 21a) denote like elements.

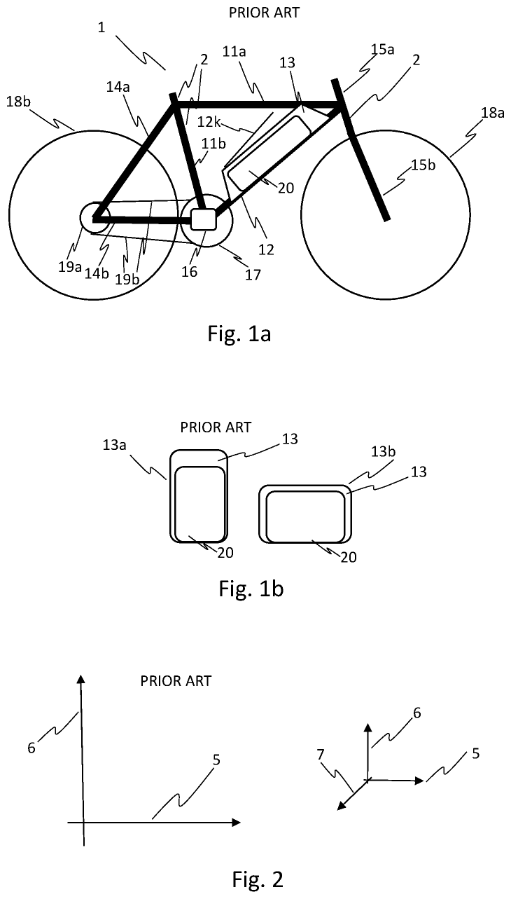

FIG. 1a shows an example of a prior art light electric vehicle, in this case a pedelec or an e-bike 1. Such vehicles are usually built around a frame 2, comprising mostly tubular elements. In FIG. 1a, the frame 2 comprises a top tube 11a, a seat tube 11b, a down tube 12, seat stays 14a and chain stays 14b. Stays 14a and 14b surround the rear wheel 18b of the bike from two sides. In the front, there is a head tube 15a and a fork 15b arranged to suspend the front wheel 18a.

Electric motor 16 assists the pedaling of the bike, coupling torsion to the chain wheel 17 along with the pedals of the bike (not shown). Torsion of the motor and pedaling is coupled to the transmission 19a of the rear wheel 18b with a chain 19b to propel the vehicle. Alternatively or additionally, transmission can be arranged in conjunction of the chain wheel 17. Battery 20 resides in a battery compartment 13, accessible with a lid or a cover 12k that can be opened or closed and to protect the battery compartment 13 from ingress of dirt, dust and water etc. The battery compartment 13 forms a section of the inside of the down tube 12 and the horizontal and vertical sides of the battery compartment 13 form a weight carrying structure of the frame 2 of the pedelec 1. Thus, in this configuration, the down tube is considerably thicker (dimension in the horizontal direction when the bike is held in a normal riding position) and taller (dimension in the vertical direction, again when the bike is held in an upright riding position) than the other tubes or stays of the frame.

Naturally, the down tube 12 is only an example of a location for a battery compartment 13. The battery compartment could be arranged into or on any other tube or stay of the vehicle, like the top tube 11a or the seat tube 11b as long as the operation of the vehicle, mechanical constraints and relevant standards permit.

In FIG. 1a, an e-bike 1 is shown as only one example of electric vehicles. Other electric vehicles include electric scooters, electric motorbikes, electric kick scooters, electric skateboards, electric unicycles or electric vehicles with more than two wheels. The term “light” in “light electric vehicle” has no standardized meaning. The present invention is advantageous in all electric vehicles where the insertion and removal of the battery is frequent in the daily use of the vehicle in contrast to e.g. an e-car where the batteries are mostly fixed into the car structures and are charged e.g. through a socket at a side of the car, connected to a charging station with a cable, with no practical option of removing the battery out of the vehicle for charging.

FIG. 1b shows two prior art orientations of operation of battery 20 in a frame or other battery holder of the vehicle as cross sections relative to the direction of the third dimension or direction. In a thin and tall orientation 13a, the long side of the cross section of the battery 20 is in the second direction. In a thick and short orientation 13b, the long side of the cross section of the battery 20 is in the first direction. A problem in the prior art is that convenient insertion and detachment and firm holding of the battery 20 into and from the battery compartment 13 in two different orientations of operation is not easy. Usually the longest dimension of the battery is in the third dimension or direction.

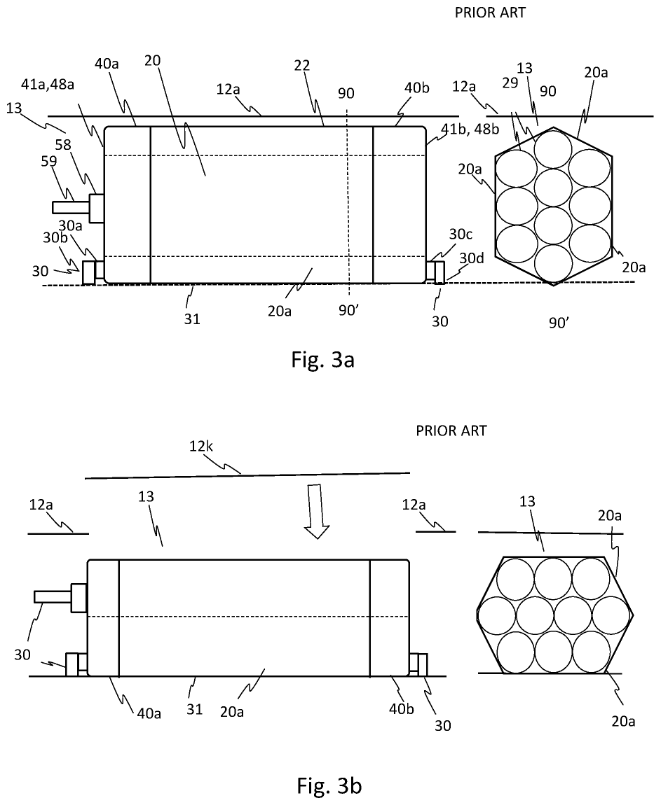

FIG. 2 shows orientations of the directions and dimensions that are used in the present application. Arrow 5 indicates the so-called first dimension or first direction, and arrow 6 the second dimension or second direction. It is evident that the dimensions are orthogonally or perpendicularly positioned relative to one another. The coordinate system in FIG. 2 can be rotated along any axis so that arrow 6, as an example, points to the “left” and arrow 5 “up”. In addition, there is also a third dimension to/from the plane spanned by the two arrows 5 and 6, also called the depth dimension or depth direction in the present application. This is show as dimension or direction 7 in FIG. 2. As the batteries are positioned in various ways and orientations in electric vehicles, description of the invention is best done with such relative (first, second and third) dimensions instead of standard frames of reference like horizontal and vertical dimensions.

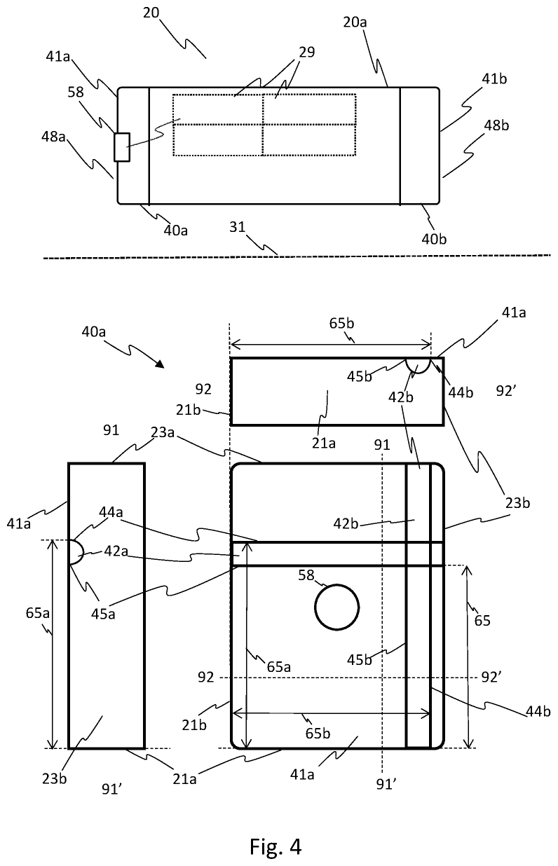

FIG. 3a shows a prior art representation of battery compartment 13, battery 20 and schematic blocks for mechanical and electric connectors 30a-30d and 58-59, respectively.

The battery is held in place mechanically with connectors 30a, 30b, 30c and 30d at both ends 48a and 48b of the battery. The ease of attachment and detachment, and the firmness of the holding of the battery depends considerably on the design of the units 30a and 30c (which are part of the detachable battery) and 30b and 30d (which are permanent parts of the vehicle). To enable the coupling of electric energy from the battery to the motor and other energy consuming parts of the vehicle, a combination of electric connectors 58 and 59 are provided at battery and vehicle side, respectively. Preferably, the connection and mating of connectors 58 and 59 (unit 59 is also called the electric socket 59) happens simultaneously and by the same motion of the battery with the connection of units 30a-30d. Of course, a separate cabling and a separate connection of connectors 58 and 59 can also be arranged. As the battery carries a considerable energy, it is important to have a good quality electric connection with virtually no chance of short circuiting the battery during insertion, holding or detachment. Similarly, as the battery can weight several kilograms, the mechanical connection 30a-30d needs to be quite robust. Electric socket 59 can be also seen as part of the battery holder 30. In FIG. 3a, battery holder 30 comprises units 30b, 30d (mechanical connectors at the vehicle side), 59 (electric socket) and 31 (connecting element adjoining the two mechanical connectors 30b and 30d in whatever form at the vehicle side). Connecting element 31 may comprise a part of the vehicle frame 2, a part of the battery compartment 13 or e.g. a sheet of material adjoining the two mechanical connectors 30b and 30d.

FIG. 3a shows the battery in two different projections, as a side view and as a cutting plane 90-90′. The cutting plane shows that the battery usually comprises several separate battery cells 29. By connecting the cells 29 in series and in parallel appropriately and then providing a connection of the cells to the connector 58, a suitable charging capacity and voltage level can be provided based on elementary electrical engineering concepts.

FIG. 3a illustrates also that a battery 20 comprises further, at both ends, end caps 40a and 40b that provide the first and second ends to the battery 20. Advantageously, the end caps comprise mechanical and/or electric connectors and other fixing points. This enables keeping the battery frame 20a relatively simple. Battery frame 20a can be e.g. a rectangular parallelepiped with thin metal sheets arranged as the four sides, with a rectangular or rounded rectangular cross section, and with fixing points for the end caps (e.g. screw threads at the first and second ends of the rectangular parallelepiped). Battery frame 20a is preferably made by extrusion of some suitable metal, but other firm materials like plastics can also be used.

FIG. 3a also shows how the battery 20 may be supported by one side of the battery compartment by a connecting element 31. This element can be, in the normal operating orientation of the vehicle, below or above the battery, or to any other direction relative to the battery 20. The connecting element 31 may support only part of the battery, e.g. the end caps 40a and/or 40b. The battery 20 or a part of it may touch connecting element 31 during holding, in other words, rest on it. Alternatively, the entire mass of the battery may be supported by the mechanical connectors 30a and 30c at both ends of the battery 20.

In FIG. 3a, the battery is inserted in a “vertical” orientation as the long side of the battery points in a vertical direction relative to the viewer. Naturally, the installation orientation of the battery 20 may be arranged to many other directions and in or on the different tubes or stays of the frame of vehicle 1 in FIG. 1a as long as the operation of the vehicle, mechanical constraints and relevant standards permit.

Also related to prior art, FIG. 3b shows that the battery can be installed also in a horizontal orientation (relative to the operation of the vehicle) where the long side of the battery is oriented horizontally. In FIG. 3b, there is a cover 12k that safeguards the battery 20 from dirt, moisture and impacts, which is important to prolong the service life of the battery 20 and its connectors 30a and 58. Cover 12k is attached to the frame 2 with an attachment and locking mechanism (locking mechanism not shown in FIG. 3a or 3b).

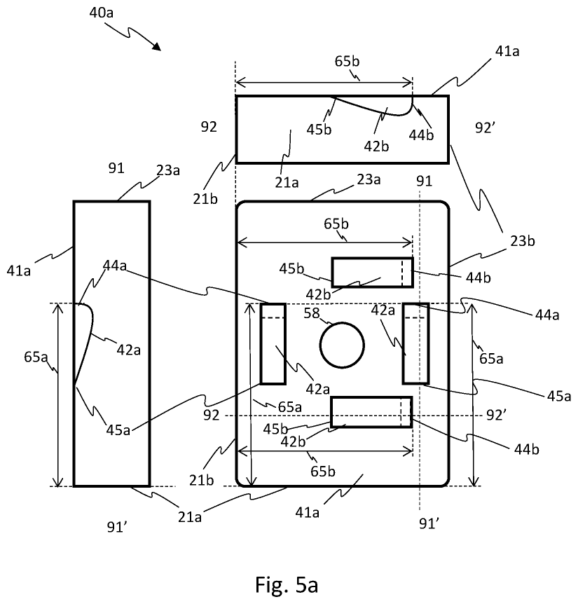

FIG. 4 shows schematically an embodiment according to the present invention. FIG. 4 shows specifically a mortise end cap 40a at the first end 48a of a battery 20 in three orientations, two of which are cutting plane projections 91-91′and 92-92′. The structure of the mortise end cap 40a in FIG. 4 is advantageous as it enables the battery 20 to be held in two different orientations in the battery holder arrangement with only minimal or no changes to the battery holder (battery holder not shown in FIG. 4).

Battery 20 also comprises a second end 48b, and an electric connector 58, in this embodiment at the mortise end cap 40a, and at least one battery cell 29 connected to the at least one electric connector 58. These parts are shown at the top of FIG. 4.

The end cap 40a is called a mortise end cap 40a as it has notches or slots into which other parts of the battery holder fit. Mortise end cap 40a is arranged into or located at the first end 48a of the battery 20. The mortise end cap 40a comprises further a first end face 41a at the first end of the battery 20, as shown in FIG. 4.

A concept of a “mortise” stems from woodworking where a mortise-tenon joint is used to hold together two pieces of wood. The purpose of a mortise end cap 40a is similar, the notches act like slots to which the wings or protrusions of the battery holder fit and support the battery mechanically when inserted, held or detached to/from the vehicle. Naturally, the holding of the battery is not permanent whereas in woodworking usually a permanent attachment of the two pieces is desired. However, the purposes of the notches and protrusion are the same—to make the temporary attachment more stable and robust.

Mortise end cap 40a comprises two base surfaces, a first direction mortise end cap base surface 21a and a second direction mortise end cap base surface 21b. A base surface is a surface that may help in supporting the battery in a robust and firm way when the battery is attached to the holder to minimize unwanted shaking and other such movement relative to the frame of the vehicle by touching and resting on the surface of a battery compartment. Alternatively, a base surface does not touch the surface of a battery compartment, in which case the weight, at least a part of it, of the battery 20 is arranged to be carried by the notches. However, the first direction mortise end cap base surface 21a and the second direction mortise end cap base surface 21b face the connecting element between the two ends (for example, the fixed end and the moving coupler; these parts not shown in FIG. 4) of the battery holder which is usually (but not necessarily) part of the “floor” of the battery compartment.

As show in FIG. 4, the first direction mortise end cap base surface 21a is arranged in a first direction 5, and the second direction mortise end cap base surface 21b is arranged perpendicularly relative to the first direction 5 in a second direction 6. In other words, mortise end cap 40a has two base surfaces in perpendicular directions relative to one another.

The mortise end cap 40a comprises one or more first direction notches. In FIG. 4, there is one first direction notch 42a. In FIG. 4, the first direction notch 42a has a distal end 44a aligned in the first direction 5 and a proximal end 45a relative to the first direction mortise end cap base surface 21a. In other words, the distal end 44a is arranged further away from the first direction mortise end cap base surface 21a than the proximal end 45a which sits between the distal end 44a and the first direction mortise end cap base surface 21a. The direction of the notch is determined by the direction of the distal end's 44a edge. This is important to note especially when the notch is narrow in the direction of its end edges, that is, its distal end and proximal end.

For directions 5 and 6, FIG. 2 is referred to.

The mortise end cap 40a comprises one or more second direction notches. FIG. 4 shows one such notch 42b. Second direction notches have a distal end 44b aligned in the second direction 6 and a proximal end 45b relative to the second direction mortise end cap base surface 21b. Analogous to first direction notches, the distal end 44b is arranged further away from the second direction mortise end cap base surface 21b than the proximal end 45b which sits between the distal end and the second direction mortise end cap base surface 21b. The direction of the notch is again determined by the direction of the distal end's 44b edge.

Again, for directions 5 and 6, FIG. 2 is referred to.

As shown in FIG. 4, there is a certain distance, a first support distance 65a, between the distal end 44a of the first direction notch 42a and the first direction mortise end cap base surface 21a. Similarly, there is a second support distance 65b between the distal end 44b the second direction notch 42b and the second direction mortise end cap base surface 21b. This arrangement allows that the battery 20 can be positioned in two different orientations into the battery holder 30 with minimal or no changes to the structure of the battery 20. With this approach, the same battery 20 fits to vehicle frames having a “thick and short” or a “thin and tall” cross section in the frame structure. Especially the battery frame 20a and the battery cells 29 therein can remain the same in either of the positions. According to an embodiment, the first support distance 65a and the second support distance 65b are equal. The base surfaces 21a or 21b may provide support to the battery 20 similarly in both orientations by touching the connecting element 31. Attaching the mortise end cap 40a to the battery frame 20a of the battery is readily accomplished e.g. with screws or glue or, if the end caps are made of metallic material, soldering or welding.

FIG. 4 illustrates, in cutting plane projections 92-92′ and 91-91′, the shape and size of the cross section of the notches 42a and 42b. As an embodiment of the invention, FIG. 4 shows that the first direction notch 42a can have a substantially concave shape in the second direction 6. In other words, then moving in the second direction 6 from the proximal end 45a to the distal end 44a of the first direction notch 42a, the notch first deepens and then gets shallower again.

In still other words, the first direction notch 42a comprises a bottom, and the bottom of the first direction notch 42a is concave in the second direction 6.

The concave shape helps in the insertion and detachment of the battery 20 into the battery holder as the notches and the related structures in the battery holder are arranged as pivot points around which the movement of the battery during insertion and detachment takes place. Similarly, the second direction notch 42b also has a substantially concave shape in the first direction 5. In other words, then moving in the first direction 5 from the proximal end 45b to the distal end 44b of the second direction notch 42b, the notch first deepens and then gets shallower again.

In still other words, the second direction notch 42b comprises a bottom, and the bottom of the second direction notch 42b is concave in the first direction 5.

As shown in FIG. 4, the one or more first direction notches 42a and the one or more second direction notches 42b are arranged at the first end face 41a.

The one or more first direction notches 42a are arranged to attach and hold the battery 20 in a battery holder.

The one or more second direction notches 42b are arranged to attach and hold the battery 20 in a battery holder.

The one or more first direction notches 42a and the one or more second direction notches 42b are arranged to attach and hold the battery 20 in a battery holder in two different orientations, that is, in two different directions.

The one or more first direction notches 42a are arranged to attach and hold the battery 20 in the first direction.

The one or more second direction notches 42b are arranged to attach and hold the battery 20 in the second direction.

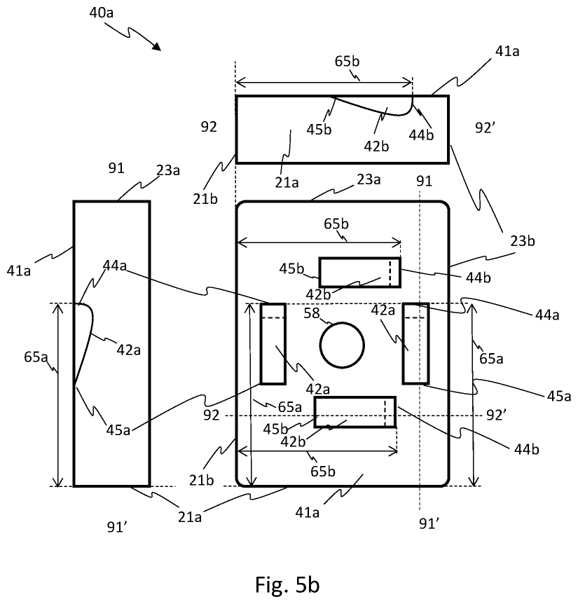

As an embodiment, FIG. 5a shows another embodiment of the current invention, in particular of the mortise end cap 40a of the battery 20. In FIG. 5a, in the mortise end cap 40a there are four notches, all having an equal size, two first direction notches 42a and two second direction notches 42b. In other words, the first direction notches 42a and the second direction notches 42b at the mortise end cap 40a all have an equal size. The first end face 41a of the battery is also at the mortise end cap 40a.

As a further embodiment of the invention, FIG. 5a shows also free surfaces that face away of the connecting element 31 (not shown) when the battery held in the battery holder. This facing direction may be the ceiling of the battery compartment. First direction mortise end cap free surface 23a is at the opposite side of the mortise end cap 40a than the first direction mortise end cap base surface 21a. Similarly, second direction mortise end cap free surface 23b is at the opposite side of the mortise end cap 40a than the second direction mortise end cap base surface 21b. Thus, the mortise end cap 40a comprises a first direction mortise end cap free surface 23a and a second direction mortise end cap free surface 23b. Further, as FIG. 5a illustrates, the mortise end cap 40a comprises one first direction notch 42a between the center of the first end face 41a and the second direction mortise end cap base surface 21b, one first direction notch 42a between the center of the first end face 41a and the second direction mortise end cap free surface 23b, one second direction notch 42b between the center of the first end face 41a and the first direction mortise end cap base surface 21a, and one second direction notch 42b between the center of the first end face 41a and the first direction mortise end cap free surface 23a. More generally, the mortise end cap 40a comprises one or more first direction notches 42a between the center of the first end face 41a and the second direction mortise end cap base surface 21b, one or more first direction notches 42a between the center of the first end face 41a and the second direction mortise end cap free surface 23b, one or more second direction notches 42b between the center of the first end face 41a and the first direction mortise end cap base surface 21a, and one or more second direction notches 42b between the center of the first end face 41a and the first direction mortise end cap free surface 23a. Again, the base surfaces 21a and 21b face the connecting element (not shown in FIG. 5a) which is usually part of the “floor” of the battery compartment.

In FIG. 5a, the center of the first end face 41a is in the middle of the electric connector 58. As represented schematically in FIG. 5a, the electric connector 58 is advantageously arranged at the center (in first and second dimensions) of the first end face 41a. In other words, the electric connector 58 is arranged at the center of the first end face 41a. Arranging the electric connector 58 to the end face 41a allows for an easy self-mating connection when the battery 20 is inserted to the battery holder, needing no separate cabling to be attached to a socket in the vehicle frame.

Electric connector 58 can also be arranged outside the first end face 41a. Alternatively, the electric connector 58 can be arranged on the first direction mortise end cap base surface 21a, or alternatively on the second direction mortise end cap base surface 21b. Arranging the electric connector to the base surfaces also allows for a self-mating electric connection when the battery is inserted into the battery holder. Electric connections arranged to the base surfaces are not shown in FIG. 5a, however.

Advantageously, as shown in FIG. 5a, the concave shapes of the first direction notch 42a and second direction notch 42b have deep ends in the distal ends 44a, 44b, and shallow ends in the proximal ends 45a, 45b. This also helps in the pivoting of the battery during insertion and detachment. As also shown in FIG. 5a, there is a certain distance, a first support distance 65a, between the distal end 44a of the first direction notches 42a and the first direction mortise end cap base surface 21a. Similarly, there is a second support distance 65b between the distal end 44b the second direction notches 42b and the second direction mortise end cap base surface 21b. According to an embodiment, the first support distance 65a and the second support distance 65b are equal.

As an embodiment, FIG. 5b shows another embodiment of the current invention, in particular of the mortise end cap 40a of the battery 20. In FIG. 5b, in the mortise end cap 40a there are again four notches, all having an equal size, two first direction notches 42a and two second direction notches 42b. In other words, the first direction notches 42a and the second direction notches 42b at the mortise end cap 40a all have an equal size. The first end face 41a of the battery is also at the mortise end cap 40a.

As a further embodiment of the invention, FIG. 5b shows also free surfaces that face to a direction away from the battery holder 30 when attached. First direction mortise end cap free surface 23a is at the opposite side of the mortise end cap 40a than the first direction mortise end cap base surface 21a. Similarly, second direction mortise end cap free surface 23b is at the opposite side of the mortise end cap 40 than the second direction mortise end cap base surface 21b. Thus, the mortise end cap 40a comprises a first direction mortise end cap free surface 23a and a second direction mortise end cap free surface 23b. Further, as FIG. 5b illustrates, the mortise end cap 40a comprises one first direction notch 42a between the center of the first end face 41a and the second direction mortise end cap base surface 21b, one first direction notch 42a between the center of the first end face 41a and the second direction mortise end cap free surface 23b, one second direction notch 42b between the center of the first end face 41a and the first direction mortise end cap base surface 21a, and one second direction notch 42b between the center of the first end face 41a and the first direction mortise end cap free surface 23a. More generally, the mortise end cap 40a comprises one or more first direction notches 42a between the center of the first end face 41a and the second direction mortise end cap base surface 21b, one or more first direction notches 42a between the center of the first end face 41a and the second direction mortise end cap free surface 23b, one or more second direction notches 42b between the center of the first end face 41a and the first direction mortise end cap base surface 21a, and one or more second direction notches 42b between the center of the first end face 41a and the first direction mortise end cap free surface 23a.

As represented schematically in FIG. 5b, the electric connector 58 is advantageously arranged at the center (in first and second dimensions) of the first end face 41a. In other words, the electric connector 58 is arranged at the center of the first end face 41a. Arranging the electric connector 58 to the end face 41a allows for a self-mating connection when the battery 20 is inserted to the battery holder, needing no separate cabling to be attached to a socket in the vehicle frame.

Electric connector 58 can also be arranged outside the first end face 41a. Alternatively, the electric connector 58 can be arranged on the first direction mortise end cap base surface 21a, or alternatively on the second direction mortise end cap base surface 21b. Arranging the electric connector to the base surfaces also allows for a self-mating electric connection when the battery is inserted into the battery holder. Electric connections arranged to the base surfaces are not shown in FIG. 5b, however. As also shown in FIG. 5b, there is a certain distance, a first support distance 65a, between the distal end 44a of the first direction notches 42a and the first direction mortise end cap base surface 21a. Similarly, there is a second support distance 65b between the distal end 44b the second direction notches 42b and the second direction mortise end cap base surface 21b. However, in contrast to FIG. 5a, as an embodiment in FIG. 5b, the first support distance 65a and the second support distance 65b are not equal. In this case bulk of the weight of the battery 20 may be carried by the notches 42a or 42b and the mating mechanical connectors at the vehicle side, depending on the orientation of the battery.

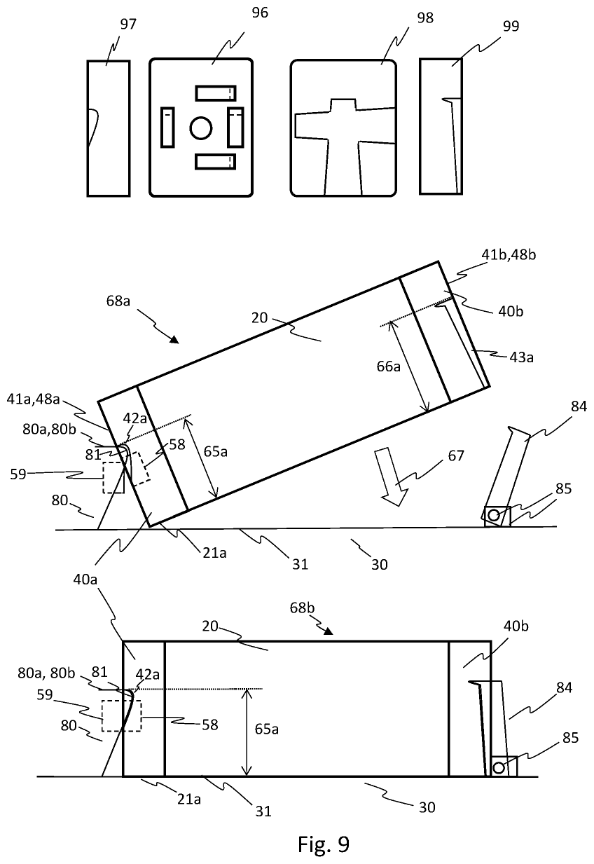

Advantageously, as shown in FIG. 5b, the concave shapes of the first direction notch 42a and second direction notch 42b have deep ends in the distal ends 44a, 44b, and shallow ends in the proximal ends 45a, 45b. This also helps in the pivoting of the battery during insertion and detachment. As also shown in FIG. 5b, there is a certain distance, a first support distance 65a, between the distal end 44a of the first direction notches 42a and the first direction mortise end cap base surface 21a. Similarly, there is a second support distance 65b between the distal end 44b of the second direction notches 42b and the second direction mortise end cap base surface 21b. As said, in the embodiment of FIG. 5b, first support distance 65a and second support distance 65b are not equal. Non-equal support distances 65a and 65b result in a different distances between the first direction mortise end cap base surface 21a and the connecting element 31 (not shown in FIG. 5b, see e.g. FIG. 9 for connecting element 31) of the battery holder 30, and between the second direction mortise end cap base surface 21b and the connecting element 31 of the battery holder 30 when the battery 20 is being held in the battery holder 30 in the first and second directions, respectively. As the weight of the battery at the first end of the battery 20 is not necessarily carried by first direction mortise end cap base surface 21a or second direction mortise end cap base surface 21b, but instead by the first direction notches 42a or second direction notches 42b and fixed end 80 of the battery holder 30 (not shown), equal distances of 65a and 65b are not needed for the correct functioning of the invention.

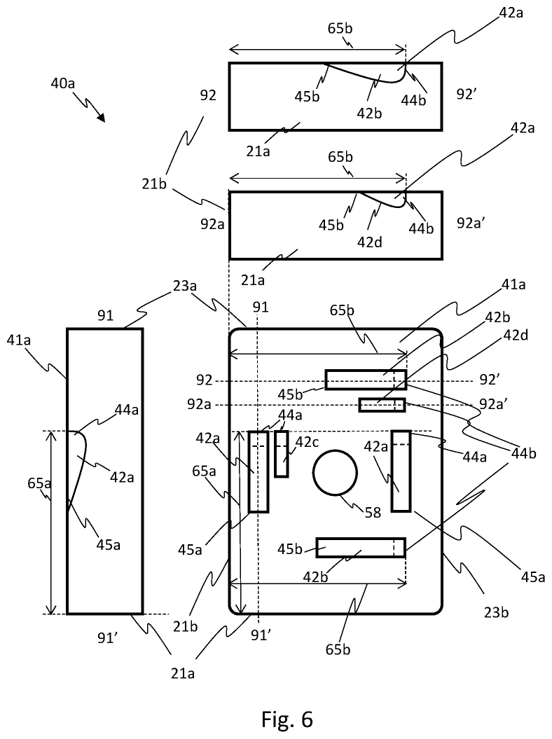

FIG. 6 illustrates yet another embodiment of the current invention. It shows a mortise end cap 40a where the first direction notches 42a and 42c and the second direction notches 42b and 42d at the mortise end cap 40a have at least two different sizes. In FIG. 6, first direction notches 42a and 42c have a different size. Similarly, second direction notches 42b and 42d have different sizes. As in FIG. 5a, the notches are positioned around the electric connector 58 which sits at the center or midpoint (in first and second dimensions) of the end face 41a of the battery, that is, at the center of surface of the mortise end cap 40a. As FIG. 6 also illustrates, the one or more first direction notches 42a, 42c have a substantially concave shape in the second direction 6, and the one or more second direction notches 42b, 42d have a substantially concave shape in the first direction 5.

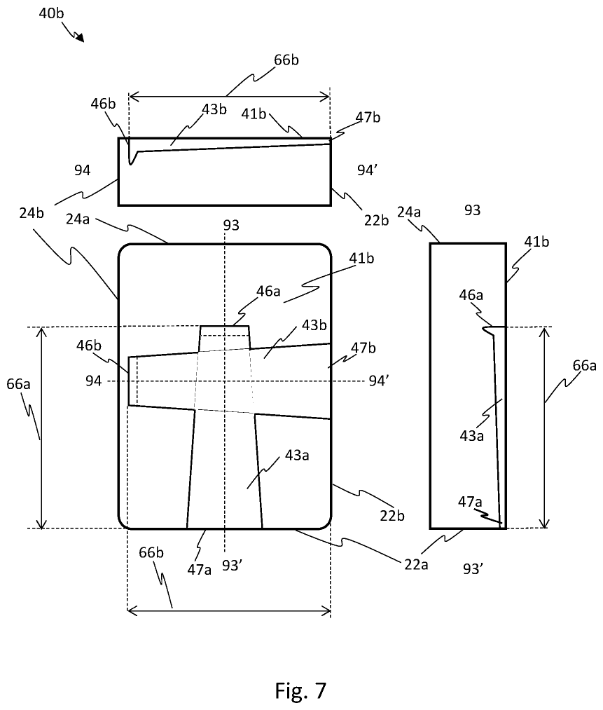

Turning to FIG. 7, the second end 48b of the battery 20 is illustrated according to an embodiment of the invention. As shown in FIG. 7, battery further comprises a grooved end cap 40b at the second end 48b of the battery 20. The grooved end cap comprises two grooved end cap base surfaces 22a and 22b arranged perpendicularly in first direction 5 and second direction 6, respectively. The grooved end cap 40b comprises also the second end face 41b of the battery.

The second end face 41b of the battery 20 is at the opposite end of the battery 20 than the first end face 41a of the battery 20.

In other words, the first end face 41a of the battery 20, and the second end face 41b of the battery 20 are at the opposite ends of the battery 20.

Similarly, the first end 48a of the battery 20, and the second end 48b of the battery 20 are the opposite ends of the battery 20.

The grooved end cap 40b also comprises one or more first direction notched grooves 43a, each having a distal end 46a aligned in the first direction and a proximal 47a end relative to the first direction grooved end cap base surface 22a (only one first direction notched groove 43a is show in FIG. 7). Again, as with notches at the first end, the direction of each of the grooves is determined by the direction of the distal end's 46a edge.

The grooved end cap further comprises one or more second direction notched grooves 43b, each a having distal end 46b aligned in the second direction and a proximal end 47b relative to the second direction grooved end cap base surface 22b. Further, the distal ends 46a of the one or more first direction notched grooves 43a are at a first latch distance 66a from the first direction grooved end cap base surface 22a. Similarly, the distal ends 46b of the one or more second direction notched grooves 43b are at a second latch distance 66b from the second direction grooved end cap base surface. The first latch distance 66a and the second latch distance 66b are equal. This helps in allowing the same latch operate the battery with the grooved end cap 40b in two orientations.

The one or more first direction notched grooves 43a, and the one or more second direction notched grooves 43b are arranged at the second end face 41b of the battery.

FIG. 7 also shows two different projections for the grooved end cap 40b along cutting planes 93-93′ and 94-94′. As the projections show, the notched grooves comprise a notch at the distal end which is substantially deeper than the rest of the groove. FIG. 7 also shows the first direction grooved end cap free surface 24a and the second direction grooved end cap free surface 24b.

In FIG. 7, according to an embodiment, the first direction notched groove 43a and the second direction notched grooves 43b are symmetric along their respective center lines 93-93′ and 94-94′ (which are also the cutting plane lines). In case of more than one first or second direction notched grooves, according to an embodiment, each of the first direction notched grooves 43a and each of the second direction notched grooves 43b are symmetric along their respective center lines.

In FIG. 7, also according to an embodiment, it is also illustrated how center line of each of the first direction notched groove 43a and the center line of the second direction notched groove 43b intersect perpendicularly. In case of more than one first direction notched grooves 43a or more than one the second direction notched groove 43b, this can be generalized so that the center lines of each of the first direction notched grooves 43a and the center lines of each of the second direction notched grooves 43b intersect perpendicularly.

As an embodiment, the electric connector 58 can be arranged on the first direction grooved end cap base surface 22a, or still alternatively on the second direction grooved end cap base surface 22b. Arranging the electric connector to the base surfaces (electric connector not shown) again allows for a self-mating electric connection when the battery is inserted into the battery holder.

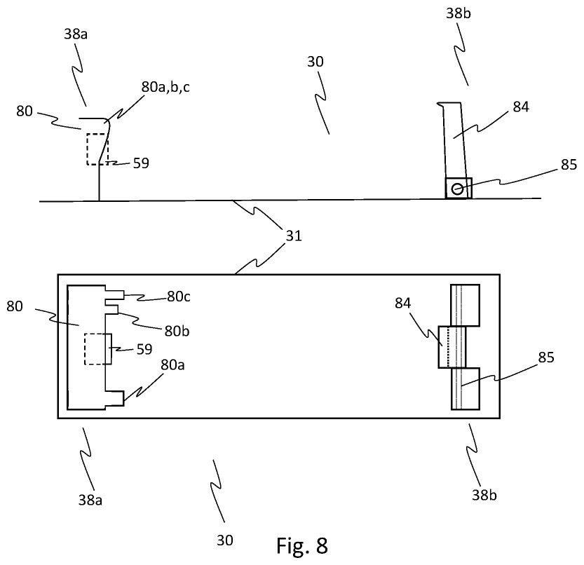

In FIG. 8, an embodiment of a battery holder 30 suitable for holding a battery 20 is shown in two projections (top projection is the side view and bottom projection the top view) to illustrate the insertion, holding and detachment of the battery 20 from the battery holder 30 and the advantages of the present invention. Battery holder 30 has two ends, first end 38a and second end 38b. In the first end 38a, a fixed end 80 (or fixed coupler 80) is provided. The fixed end 80 is provided with an electric socket 59 that is arranged to mate with the battery's electric connector (battery not shown in FIG. 8). Fixed end 80 is also provided with one or more protrusions or wings 80a against which the battery, especially the notches at the mortise end cap, can pivot. As shown in bottom part of FIG. 8, there can be e.g. three separate wings or protrusions 80a, 80b and 80c. The fixed end 80 is may be arranged to hold a battery 20 having a mortise end cap 40a as given in FIG. 6 for having a matching notch/wing arrangement.

In FIG. 8, in the second end 38b, a moving coupler 84 is provided. Moving coupler 84 can rotate around a hinge and it can be held in a locked position with a lock, both hinge and lock being parts of unit 85. The fixed end 80 and the moving coupler 84 are held together with a connecting element 31.

FIG. 9 shows the insertion of the battery 20 to the battery holder 30.

Insertion of the battery 20 is shown in two steps, step 68a where the insertion starts and battery rotates (also called the battery rotation step 68a) and moves in the direction of the arrow 67, and step 68b, where the insertion is completed and the battery is locked and held in a holding position. At the top part of FIG. 9, four projections are show. Projections 96 and 98 show the first (41a) and second end faces (41b) of the battery in the orientation of the battery's insertion. This orientation of the battery is the so-called thin and tall orientation, where the size of the battery is longer in the second dimension than in the first dimension. Similarly, 97 and 99 match the orientations of the battery 20 in a sideway projection. In the arrangement presented in FIG. 9, the mortise end cap 40a of the battery 20 comprises four notches, and the fixed end 80 comprises two protrusions 80a and 80b (only one protrusion 80a is shown due to side projection, protrusion 80b being behind protrusion 80a).

In this embodiment, “during insertion” and “during detachment” means that during at least part of the insertion or at least part of the detachment, the battery 20 rotates around the at least one support surface 81 of the battery holder 30.

When the battery 20 is inserted to the battery holder 30, that is, during insertion, a support surface 81 at and around the tip of the protrusion 80a guides and holds the battery 20 by the first direction notches 42a of the mortise end cap and helps in rotating the battery 20 firmly so that the second end 48b of the battery 20 can move substantially radially towards the moving coupler 84 in a battery rotation step 68a. The distal end of the notch 42a is at the first support distance 65a from the first direction mortise end cap base surface 21a. There are two protrusions 80a and 80b and two first direction notches 42a in FIG. 9, but the other protrusions and notches are not visible due to the sideway projection. As the battery 20 rotates, the electric connector 58 in the battery and electric socket 59 in the fixed end mate at the end of the rotation of the battery. In FIG. 9, the rotation is clockwise in the viewing direction.

In step 68b, the battery is held and locked in a holding position by the moving coupler 84 and its lock and hinge mechanism 85. Moving coupler 84 grabs the notch of the notched groove 43a of the grooved end cap 40b, holding the second end 48b of the battery firmly in place. By the same token, the first end 48a of the battery 20 is held steady by the fixed end 80 or fixed coupler 80. The protrusions 80a and 80b are at least partially inside the first direction notches 42a, and the first direction mortise end cap base surface 21a lies on the connecting element 31. Alternatively, the protrusions 80a and 80b carry at least part of the weight of the battery by the two attached first direction notches 42a.

When the battery 20 is detached from the battery holder 30, the lock and hinge mechanism 85 is opened and the battery 20 is rotated counterclockwise to free it from the moving coupler 84 in the projection of FIG. 9. Again, the support surface 81 around the tip of the protrusions 80a and 80b guides and holds the battery 20 by the first direction notches 42a of the mortise end cap and helps in rotating the battery 20 firmly so that the second end 48b of the battery 20 can move substantially radially away from the moving coupler 84.

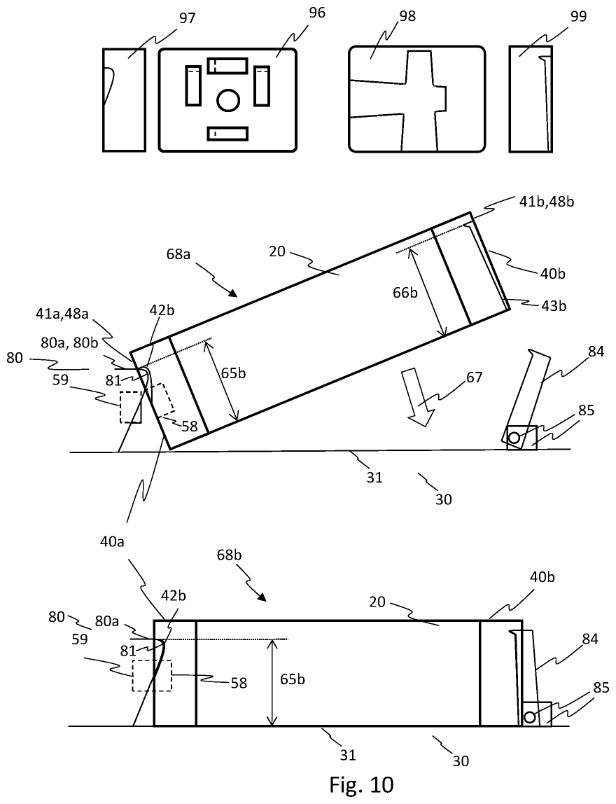

FIG. 10 corresponds to FIG. 9 but in FIG. 10, the battery is in the thick and short type of orientation. In FIG. 10, the support distance is the second support distance 65b, and during holding of the battery, protrusions 80a and 80b are in the second direction notches 42b (again, only one notch shown due to projection). In the arrangements of FIGS. 9 and 10, the only change needed in this embodiment is to adjust the distance and orientation of the electric socket 59 from and relative to the connecting element 31. In FIG. 10, the electric socket needs to be attached a bit lower than in FIG. 9. There is also a 90 degrees rotation in the orientation of the electric socket 59 in FIGS. 9 and 10. In other words, the electric socket 59 is provided with a connection to the fixed end 80 that can be arranged in two different orientations having a 90 degree rotation in the axis in the third direction in the coordinate system used in the present application. This adjustment in height and rotation is easily accomplished by e.g. threads at suitable heights in the fixed end 80, and a square installation plate for the electric socket 59 with screw-holes at each four corners (installation plate not shown).

In the end of the moving coupler 84, at the second end 48b of the battery 20, the situation is analogous. The same moving coupler 84 and its hinge and locking mechanism 85 can lock the battery 20 in the holding position by holding the notches of the notched grooves 43a and 43b of the grooved end cap 40b.

More generally, FIGS. 9 and 10 depict a battery holder arrangement that comprises a battery 20 according to the present invention and its embodiments. The battery holder arrangement comprises a battery holder 30, and the battery holder 30 comprises a fixed end 80. The fixed end 80 comprises one or more protrusions 80a. Each of the one or more protrusions 80a comprise a support surface 81.

At least one first direction notch 42a is arranged to mate with at least one protrusion 80a when the battery is held and operated in the first direction, as shown in FIG. 9, and at least one second direction notch 42b is arranged to mate with at least one same protrusion 80a when the battery is held and operated in the second direction, as shown in FIG. 10, the at least one protrusion 80a arranged to support the battery during holding of the battery 20 in the battery holder 30. Here, “battery is held and operated” in a direction means that the fixed end 80 is arranged to accept a mortise end cap 40a having notches in a certain (first or second) direction. In other words, if the fixed end 80 is arranged to accept a battery and its mortise end cap 40a having notches in the first direction, the battery is held and operated in the first direction. Similarly, if the fixed end 80 is arranged to accept a battery and its mortise end cap 40a having notches in the second direction, the battery is held and operated in the second direction. In other words, the protrusions and the notches mate. Simultaneously, when battery is operated in a direction, the electric connector 58 and the electric socket 59 are arranged to mate, and the resulting electric connection provides electric energy to the vehicle. As the distance of the electric connector 58 to the connecting element 31 usually differs in different orientations of operation when the battery is attached to the battery holder 30, a small adjustment to the fixed end, in particular to the location of the electric socket 59, is maybe needed when changing or arranging the orientation of operation from one orientation to another.

For the purposes of this text, to “mate” means that two interconnecting parts, for example the first direction notch 42a and the protrusion 80a, or the second direction notch 42b and the protrusion 80a, have mutually complementing shapes such that a firm and secure, yet nonpermanent holding and connection is provided.

In other words, the protrusion 80a provides a counterpart to the first direction notch 42a such that the first direction notch 42a may at least partly receive or accommodate the protrusion 80a.

In still other words, the protrusion 80a provides a counterpart to the second direction notch 42b such that the second direction notch 42b may at least partly receive or accommodate the protrusion 80a.

FIGS. 9 and 10 show how, as an embodiment, battery 20 may rotate around the support surface 81 of the at least one protrusion 80a of the battery holder 30 during insertion of the battery 20 to the battery holder 30, and during detachment of the battery 20 from the battery holder 30.

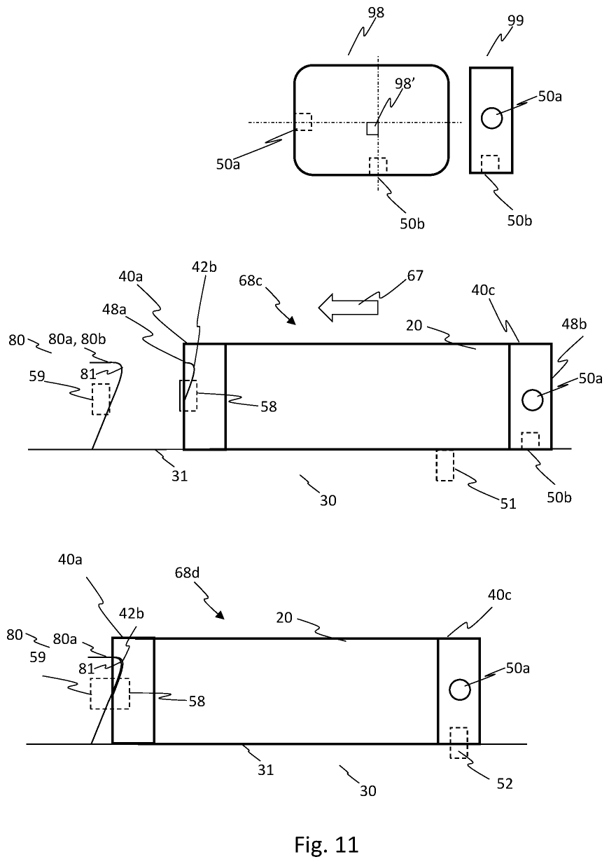

FIG. 11 corresponds to FIGS. 9 and 10 but in FIG. 11, the battery 20 is held in the attached position 68d with a bolt 51, 52 that may be attached to the threads of one or more first direction threaded holes 50a or one or more second direction threaded holes 50b (only one first direction threaded hole 50a and one second direction threaded hole 50b shown in FIG. 11) at a threadhole end cap 40c. In other words, the battery 20 further comprises a threadhole end cap 40c at the second end 48b of the battery 20. The threadhole end cap 40c comprises one or more first direction threaded holes 50a and one or more second direction threaded holes 50b. In position 68c, the battery 20 is being attached to the battery holder 30 by sliding the battery 20 towards the fixed end as shown in the middle portion of FIG. 11 with arrow 67. One or more first direction threaded holes 50a and one or more second direction threaded holes 50b are arranged so that their axes are perpendicular relative to each other as shown in projection 98 and label 98′ of Figure. In other words, one or more first direction threaded holes 50a and one or more second direction threaded holes 50b are arranged perpendicularly relative to each other. Middle portion of FIG. 11 shows the bolt 51 in an open position, and the bottom portion of FIG. 11 shows the bolt 52 affixed and holding the second end 48b of the battery by the threadhole end cap 40c.

In FIG. 11, a battery holder arrangement is also illustrated. The battery holder arrangement comprises a battery 20 as defined in the present application. The battery holder arrangement comprises a battery holder 30, the battery holder 30 comprising a fixed end 80, the fixed end 80 comprising one or more one protrusions of which only 80a shown. Each of the one or more protrusions 80a comprises a support surface 81. At least one first direction notch (first direction notch not shown but FIG. 9 shows a corresponding first direction notch 42a) is arranged to mate with at least one protrusion 80a when the battery is held and operated in the first direction, and at least one second direction notch 42b is arranged to mate with at least one same protrusion 80a when the battery is held and operated in the second direction. The at least one protrusion 80a is arranged to support the battery during holding of the battery 20 in the battery holder 30. An alternative to the sliding of the battery 20 to the battery holder as described above in relation to FIG. 11 is that the battery rotates around the support surface 81 of the at least one protrusion 80a of the battery holder 30 during insertion of the battery 20 to the battery holder 30, and during detachment of the battery 20 from the battery holder 30.

The invention has been described above with reference to the examples shown in the figures. However, the invention is in no way restricted to the above examples but may vary within the scope of the claims.

1-15. (canceled)

16. A battery for a light electric vehicle, the battery comprising a first end, a second end, at least one electric connector and at least one battery cell connected to the at least one electric connector, wherein the battery comprises:
a mortise end cap at the first end of the battery, the mortise end cap comprising
a first end face,
a first direction mortise end cap base surface and
a second direction mortise end cap base surface, the first direction mortise end cap base surface arranged in a first direction and the second direction mortise end cap base surface arranged perpendicularly relative to the first direction in a second direction,
one or more first direction notches each having a distal end aligned in the first direction and a proximal end relative to the first direction mortise end cap base surface, and
one or more second direction notches each having a distal end aligned in the second direction and a proximal end relative to the second direction mortise end cap base surface;
the distal end of each of the one or more first direction notches and the first direction mortise end cap base surface are at a first support distance from each other, and
the distal end of each of the one or more second direction notches and the second direction mortise end cap base surface are at a second support distance from each other.

17. The battery according to claim 16, wherein the first support distance and the second support distance are equal.

18. The battery according to claim 16, wherein the one or more first direction notches have a substantially concave shape in the second direction and the one or more second direction notches have a substantially concave shape in the first direction.

19. The battery according to claim 16, wherein the one or more first direction notches and the one or more second direction notches at the mortise end cap all have an equal size.

20. The battery according to claim 16, wherein the one or more first direction notches and the one or more second direction notches at the mortise end cap have at least two different sizes.

21. The battery according to claim 16, wherein the mortise end cap comprises:
a first direction mortise end cap free surface and a second direction mortise end cap free surface, and
one or more first direction notches between the center of the first end face and the second direction mortise end cap base surface, and
one or more first direction notches between the center of the first end face and the second direction mortise end cap free surface, and
one or more second direction notches between the center of the first end face and the first direction mortise end cap base surface, and
one or more second direction notches between the center of the first end face and the first direction mortise end cap free surface.

22. The battery according to claim 16, wherein the battery further comprises a threadhole end cap at the second end of the battery, the threadhole end cap comprising one or more first direction threaded holes and one or more second direction threaded holes, one or more first direction threaded holes and one or more second direction threaded holes arranged perpendicularly relative to each other.

23. The battery according to claim 16, wherein the battery further comprises a grooved end cap at the second end of the battery comprising:
two grooved end cap base surfaces arranged perpendicularly in the first direction and the second direction, respectively, and
one or more first direction notched grooves, each having a distal end aligned in the first direction and a proximal end relative to the first direction grooved end cap base surface, and
one or more second direction notched grooves, each a having distal end aligned in the second direction and a proximal end relative to the second direction grooved end cap base surface, and in that
the distal end of each of the one or more first direction notched grooves is at a first latch distance from the first direction grooved end cap base surface,
the distal end of each of the one or more second direction notched grooves is at a second latch distance from the second direction grooved end cap base surface, and
the first latch distance and the second latch distance are equal.

24. The battery according to claim 23, wherein each of the first direction notched grooves and each of the second direction notched grooves are symmetric along their respective center lines.

25. The battery according to claim 24, wherein the center lines of each of the first direction notched grooves and the center lines of each of the second direction notched grooves intersect perpendicularly.

26. The battery according to claim 16, wherein the electric connector is arranged at the center of the first end face.

27. The battery according to claim 16, wherein the electric connector is arranged
on the first direction mortise end cap base surface, or
on the second direction mortise end cap base surface.

28. The battery according to claim 23, wherein the electric connector is arranged
on the first direction grooved end cap base surface, or
on the second direction grooved end cap base surface.

29. The battery holder arrangement for light electric vehicles, wherein the battery holder arrangement comprises:
a battery according to claim 16,
a battery holder, the battery holder comprising:
a fixed end, the fixed end comprising one or more protrusions, each of the one or more protrusions comprising a support surface;
and in that at least one first direction notch is arranged to mate with at least one protrusion when the battery is held and operated in the first direction, and
at least one second direction notch is arranged to mate with at least one same protrusion when the battery is held and operated in the second direction,
the at least one protrusion arranged to support the battery during holding of the battery in the battery holder.

30. The battery holder arrangement according to claim 29, wherein the battery rotates around the support surface of the at least one protrusion of the battery holder during insertion of the battery to the battery holder, and during detachment of the battery from the battery holder.
